(19) United States
(12) Patent Application Publication
(10) Pub. No.: US 2015/0006029 A1
(43) Pub. Date: Jan. 1, 2015

(54) CONTROL STRUCTURE OF VEHICLE

(71) Applicants: Alpha Corporation, Yokohama-shi, Kanagawa (JP); Nissan Motor Co., LTD., Yokohama-shi, Kanagawa (JP)

(72) Inventors: Takashi Ono, Yokohama-shi (JP); Jun Endo, Yokohama-shi (JP); Kazuya Tanaka, Yokohama-shi (JP); Shun Rai, Yokohama-shi (JP); Wataru Hirai, Yokohama-shi (JP)

(73) Assignee: Alpha Corporation, Yokohama-shi, Kanagawa (JP)

(21) Appl. No.: 14/377,548

(22) PCT Filed: Mar. 27, 2013
(86) PCT No.: PCT/JP2013/059085

§ 371 Date: Aug. 8, 2014

(30) Foreign Application Priority Data
Mar. 30, 2012 (JP) 2012-080121

(51) Int. Cl. E05F 15/20

(52) U.S. Cl. CPC E05F 15/2023; E05F 2015/2061
USPC 701/36

(57) ABSTRACT

An object of the present invention is to provide a control structure of a vehicle capable of reliably responding to an operation intention of a user outside the vehicle. The structure includes: a reflective optical sensor 5 configured to detect an entry of a detection target 4 into a recessed hollow section 1 formed in a vehicle outer wall according to a change in an amount of reflected beams of detection light 3 emitted from a light emitting opening 2 provided in one wall surface of the recessed hollow section 1 toward another wall surface of the recessed hollow section 1; and a controller 6 configured to operate a certain control target 7 when the reflective optical sensor 5 detects the entry of the detection target 4 into the recessed hollow section 1.

### TECHNICAL FIELD

The present invention relates to a control structure of a vehicle.

### BACKGROUND ART

As a control structure of a vehicle configured to perform a certain operation when a sensor installed in a vehicle body detects a user or the like, there has been known one described in Patent Document 1.

In this conventional example, a touch sensor is used as the sensor and is fixed to a rearmost pillar of the vehicle. When the user places a hand above the touch sensor and then moves the hand up and down, the touch sensor detects the motion of the hand. A controller receives the detection signal and drives a back door in a vertical direction.

However, this conventional example requires the user to place a hand above the touch sensor to operate the back door. For this reason, if both hands are full of goods or the like, the user has to put down the goods for a moment for the operation. Hence, the conventional example has such a disadvantage that the usability is not always favorable.

Further, in the conventional example, it is stated that an optical sensor, ultrasound, image recognition, thermal sensor, or the like can be used as the sensor. Nevertheless, even by use of any of these sensors, it is difficult to distinguish a case the user approaches the vehicle from a case where a person, an animal, or etc., other than the user approaches the vehicle. Hence, unintentional door opening and closing cannot be prevented. This brings about a problem of a low operation reliability.

### PRIOR ART DOCUMENT

### Patent Document

Patent Document 1: Japanese Patent Application Publication No. 2005-307692

### SUMMARY OF THE INVENTION

### Problems to be Solved by the Invention

The present invention has been made to overcome the above-described disadvantages. An object of the present invention is to provide a control structure of a vehicle capable of reliably responding to an operation intention of a user outside the vehicle.

### Means for Solving the Problem

The present invention achieves the above object by providing a control structure of a vehicle including:
a reflective optical sensor 5 configured to detect an entry of a detection target 4 into a recessed hollow section 1 formed in a vehicle outer wall according to a change in an amount of reflected beams of detection light 3 emitted from a light emitting opening 2 provided in one wall surface of the recessed hollow section 1 toward another wall surface of the recessed hollow section 1; and
a controller 6 configured to operate a certain control target 7 when the reflective optical sensor 5 detects the entry of the detection target 4 into the recessed hollow section 1.

A vehicle includes:
a reflective optical sensor 5 configured to detect an entry of a detection target 4 into a recessed hollow section 1 formed in a vehicle outer wall according to a change in an amount of reflected beams of detection light 3 emitted from a light emitting opening 2 provided in one wall surface of the recessed hollow section 1 toward another wall surface of the recessed hollow section 1; and
a controller 6 configured to operate a certain control target 7 when the reflective optical sensor 5 detects the entry of the detection target 4 into the recessed hollow section 1. The reflective optical sensor 5 receives at a light receiving portion 5a thereof the reflected beams of the detection light 3 emitted into the recessed hollow section 1 from the light emitting opening 2 provided in the wall surface of the recessed hollow section 1 formed in the vehicle outer wall, and detects the entry of the detection target 4 into the recessed hollow section 1 according to a change in an amount of beams thus received (received beam level). As the reflective optical sensor 5, an infrared ray reflective beam sensor can be used. The light emitting opening 2 of the reflective optical sensor 5 can be set to face an outer panel of the vehicle, or an operation handle, decorative member, or the like fixed to the outer panel.

The recessed hollow section 1 may be a portion whose edge line appears in a closed shape in the vehicle outer wall, like a handle recessed portion for holding a door handle by a hand, or may be otherwise a recessed portion having an edge line whose end points are never connected to each other. Alternatively, the recessed hollow section 1 may be not only a distinguishable narrow region, but also the entire region whose wall surface is regressed toward the inside of the vehicle from a plane connecting edge lines.

Various types of the control target 7 of the controller 6 can be designed, such as actuators for a lighting system and electronic authentication device in addition to driving sources for an locking and unlocking actuator, a power door actuator, and the like.

In the present invention in which an entry of the detection target 4 into the recessed hollow section 1 is detected to then operate a certain control target 7, the predetermined operation can be performed merely by inserting a hand, goods, or the like into the recessed hollow section 1. Accordingly, the convenience is improved.

Moreover, since the reflective optical sensor 5 is used as a sensor, this eliminates the need to further provide, unlike a case of a transmissive optical sensor, a light receiving opening at a position opposite to the light emitting opening 2. Accordingly, for vehicles supposedly used outdoors, the possibility that the light receiving and emitting openings are closed due to dust or the like can be reduced, and the operation reliability is improved.

Further, the reflective optical sensor 5 emits light toward a wall surface of the recessed hollow section 1, more accurately, the wall surface of the recessed hollow section 1 is other than a wall surface in which the light emitting opening 2 is provided. Accordingly, while a person, an animal, a trash, etc., other than a user approaches the vehicle, no detection signal is outputted from the reflective optical sensor 5, or the amount of the light is quite small in comparison with a determination threshold. This makes it possible to prevent an unintentional operation attributable to an approach of an animal or the like to the vehicle.

Not all the detection light 3 has to reach the wall surface of the recessed hollow section 1 Like a spot on an optical axis as in a case of using a single beam-emitting source, it is only necessary that a maximum light intensity region or its nearby region be situated on the wall surface of the recessed hollow section 1.

In this case, if the control structure of a vehicle is configured in such a manner that an optical axis of the reflective optical sensor 5 is directed to an inner side of the vehicle, this makes it possible to reduce the amount of beams emitted to the outside of the recessed hollow section 1, so that the detection precision can be further increased.

Further, the direction in which the light emitting opening 2 is opened may be vertical, horizontal, diagonal, or the like, or can be determined as appropriate. Nevertheless, if the control structure of a vehicle is configured in such a manner that the reflective optical sensor 5 is positioned with the light emitting opening 2 being directed downward, this reduces the possibility that rainwater, dust, or the like comes into contact with the light emitting opening 2. Accordingly, the light emitting opening 2 is rarely closed.

As described above, various types of the control target 7 of the controller 6 can be designed, such as a locking and unlocking actuator. Nevertheless, in a case where the control target 7 is an opening and closing operation controller for a door of the vehicle, this makes it possible to control an operation of opening and closing the door merely by inserting a hand into the recessed portion for holding a door handle by a hand, or the like.

The opening and closing operation controller configured to control an operation of opening and closing a power back door, in particular, requires the user having goods in hand to merely insert the goods into the recessed hollow section 1 to perform the opening and closing operation. This makes it possible to improve the workability for loading and unloading goods.

The opening and closing operation controller can be configured to control, in addition to the operation of opening and closing the power door, an operation of locking and unlocking a door, or operations of preparing the opening and closing operation such as outputting a request signal to an electronic key possessed by the user prior to the locking and unlocking.

Moreover, the control structure of a vehicle can be configured in such a manner that
the determination threshold for the detection target 4 used in the reflective optical sensor 5 is determined according to a received beam level at the light receiving portion 5a for a certain time before the determination.

The reflective optical sensor 5 is configured to detect the detection target 4 according to an increase in the amount of reflected beams at the light receiving portion 5a when the detection target 4 enters the recessed hollow section 1. The determination is made by comparing the received beam level at the light receiving portion 5a with the determination threshold. Nevertheless, even when the vehicle model is the same, the wall surfaces of the recessed hollow sections 1 of the vehicles are formed from materials having different reflection properties in many cases. For example, vehicles may be surface-treated with different colors. Hence, the received beam levels at the light receiving portions 5a are different in an initial state before the detection target 4 is inserted into the recessed hollow section 1.

Furthermore, unlike indoor facilities, a vehicle has different received beam levels at the light receiving portion 5a in the initial state, depending on the brightness at a stopping or parking site, how much dirt is on the light emitting opening 2 or on a reflection surface, snow accumulated on the wall surface, and the like. Hence, these serve as factors of lowering the determination precision.

Nonetheless, in the present invention in which the determination threshold for the detection target 4 used in the reflective optical sensor 5 is determined according to the received beam level at the light receiving portion 5a for a certain time before the determination, the determination threshold is adjusted to a value appropriate for the use environment. Accordingly, the determination precision is improved.

The determination threshold can be determined as an average value, maximum value, intermediate value, or the like obtained by applying an appropriate statistical processing to the received beam level at the light receiving portion 5a within a certain time before a detection operation on the detection target 4. Further, the determination operation can also be performed according to a statistical determination of a significant difference between the initial state and the determination operation, for example, by statistically testing an average value in the initial state and an average value during the detection operation.

### Effect of the Invention

The present invention makes it possible to prevent an output of an operation signal attributable to an approach of a person or the like other than a user to the vehicle. This enables a reliable response to an operation intention of the user outside the vehicle.

### BRIEF DESCRIPTION OF THE DRAWINGS

FIG. 1 shows views for illustrating the present invention: (a) is a view of a vehicle seen from the back, (b) is a side view, and (c) is a cross-sectional view taken along the line 1C-1C in (a).

FIG. 2 is a flowchart for illustrating an operation of a controller.

FIG. 3 is a timing chart of a reflective optical sensor.

### MODE FOR CARRYING OUT THE INVENTION

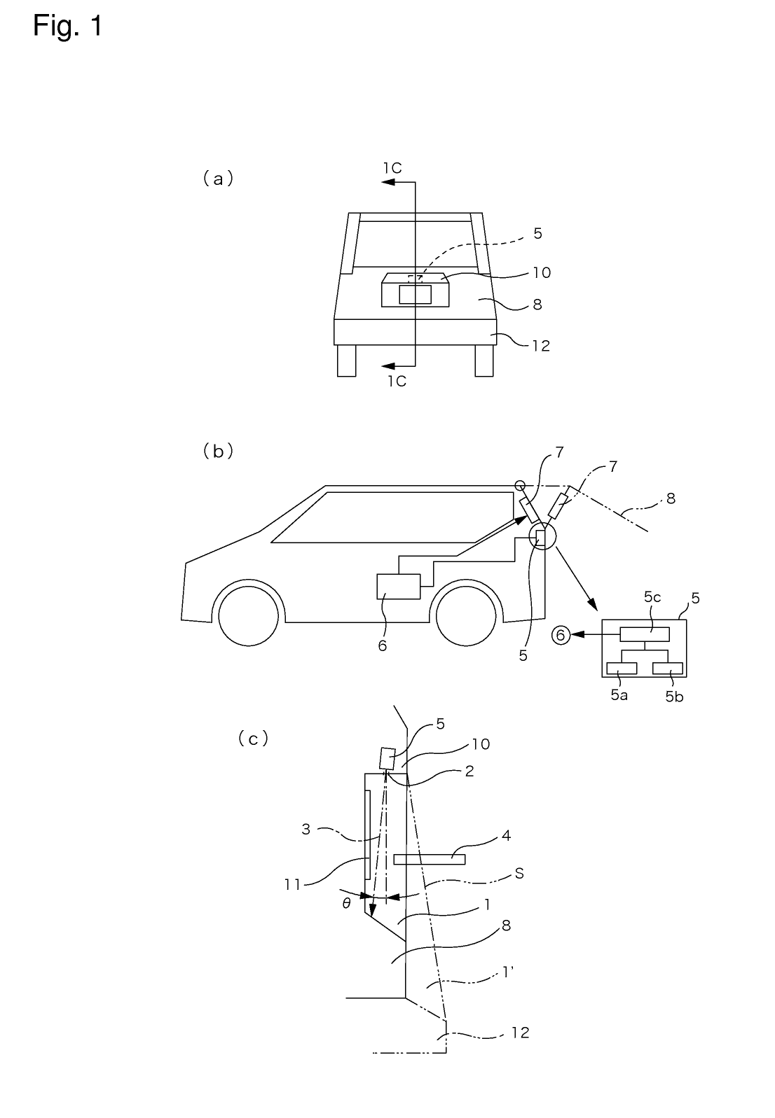

FIG. 1 shows a vehicle to which the present invention is applied. In this embodiment, the vehicle includes a back door 8 configured to close an opening provided at the back of a vehicle body. The back door 8 is formed as a so-called power back door configured to be driven to open and close by an appropriate driver (control target 7) such as a gas damper. To control opening and closing of the back door 8, the back door 8 is provided with a reflective optical sensor 5, and a controller 6 configured to control the driver 7 is provided inside the vehicle. The controller 6 may be incorporated in an on-board computer installed in the vehicle.

On the back door 8, a license-plate attachment recess surrounded by a license plate finisher 10 is formed, and a license plate 11 is fixed in the license-plate attachment recess.

The reflective optical sensor 5 is a so-called infrared-ray reflective optical sensor 5 and configured to detect the presence or absence of a certain detection target 4 according to an amount of reflected beams (received beam level) of an infrared ray emitted as detection light 3 from the detection target 4. The reflective optical sensor 5 is formed as one unit including: an appropriate number of light emitting portions 5b configured to emit the detection light 3; a light receiving portion 5a configured to receive reflected beams of the detection light 3 by the detection target 4, the detection light 3 having been emitted from the light emitting portions 5b; and a sensor controlling portion 5c configured to adjust the timing of emitting the detection light 3, adjust a threshold, compare the threshold with an amount of beams thus received (received beam level), and perform other operations. The activation and termination of the reflective optical sensor 5 are controlled by the above-described controller 6. When the received beam level exceeds the threshold, the reflective optical sensor 5 outputs a detection signal.

The above-described license-plate attachment recess is a recessed hollow section 1. To detect an entry of the detection target 4 into the recessed hollow section 1, the reflective optical sensor 5 is incorporated in a ceiling wall portion of the recessed hollow section 1, more accurately in the license plate finisher 10, in such a manner as to emit the detection light 3 from the ceiling wall portion toward a bottom wall portion of the recessed hollow section 1.

To emit the detection light 3 from the reflective optical sensor 5 into the recessed hollow section 1, a light emitting opening 2 is provided in a ceiling wall surface of the recessed hollow section 1.

Moreover, to prevent the detection light 3 from leaking to the outside of the recessed hollow section 1, the reflective optical sensor 5 is provided in such a manner that an optical axis of the reflective optical sensor 5 is displaced toward the inside of the vehicle by an appropriate angle (θ) with respect to a vertical direction as shown in FIG. 1(c).

Note that, in the foregoing, the description has been given of the case where the license-plate attachment recess is designed as the recess for detecting an entry of the detection target 4, that is, the recessed hollow section 1. Nevertheless, other than this, for example, as shown in FIG. 1(c),

a region regressed to a plane (S) connecting an upper edge of the license-plate attachment recess, serving as an upper edge line, to an upper edge of a rear bumper 12 may be designed as a recessed hollow section 1′, and the reflective optical sensor 5 may be provided in such a manner that an entry of the detection target 4 into the recessed hollow section 1′ can be detected.

The operation of opening and closing the power back door of the vehicle configured as described above will be described.

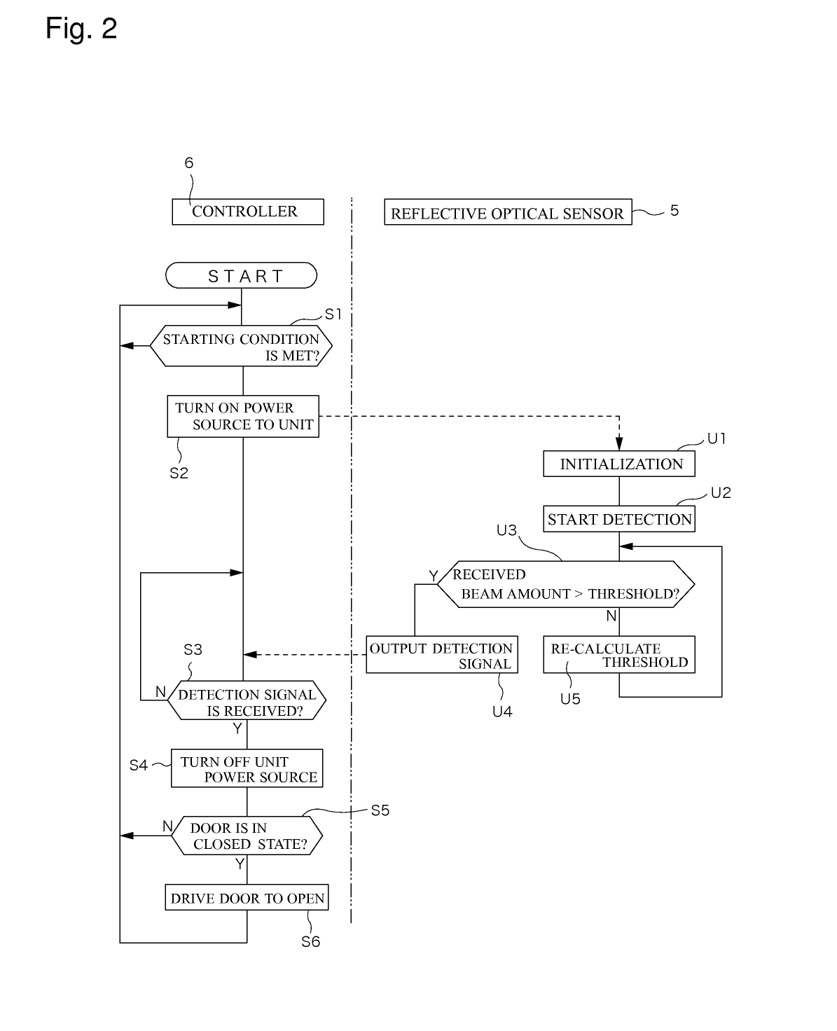

As shown in FIG. 2, at the start of the control, the controller 6, first, detects whether or not current conditions meet an operation control mode for the power back door 8 (Step S1). Whether or not the conditions meet the operation control mode can be appropriately determined in the specifications. For example, the conditions can be set: when the gear stick is at the parking position; when the door is in an unlocked state; or, when the presence of an unillustrated electronic key is detected within a certain area from the vehicle; specifically, for example, a response signal is successfully received from an electronic key within a certain period after a request signal is outputted to the electronic key.

If the starting conditions are met in Step S1, the controller 6 activates the reflective optical sensor 5 (Step S2), and waits until a detection signal from the reflective optical sensor 5 is received (Step S3).

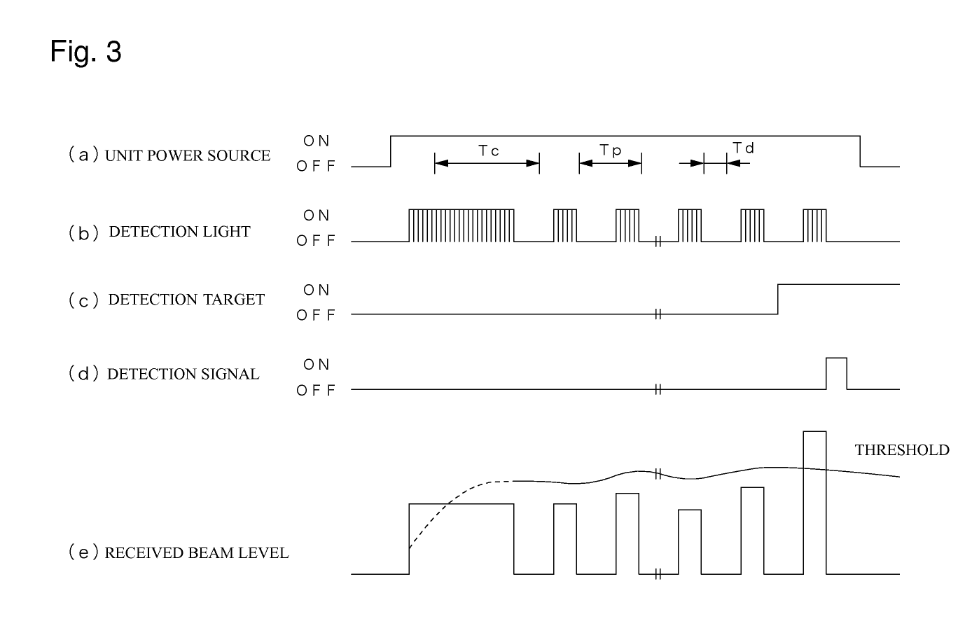

To reduce an influence from external disturbing light, the reflective optical sensor 5 is configured to emit the detection light 3 in the form of light pulses, and determine a received beam level at the light receiving portion 5a in accordance with the timing of the pulsed output. When activated in Step S2, first, the reflective optical sensor 5 emits an appropriate number of the detection light 3 pulses within a predetermined certain calibration time (Tc) as shown in FIG. 3 to execute initialization processing (Step U1).

The initialization processing is to calibrate a determination threshold for the detection target 4 according to a use environment or a use condition such as a change in the amount of emitted beams due to dirt on the light emitting opening 2, a change in the amount of reflected beams due to conditions of a reflection surface such as color and dirt, or a change in the amount of external light due to the brightness of the surrounding, by detecting the received beam level of beams reflected from the bottom wall portion of the recessed hollow section 1. No detection operation on the detection target 4 is performed in the initialization processing unlike a determination operation to be described later.

In the present embodiment, the determination threshold is calculated by adding a predetermined threshold constant to an average value of the received beam level at the light receiving portion 5a within the calibration time (Tc).

When the initialization processing is terminated as described above, a detection operation is started (Step U2). The detection operation is performed such that the pulsed detection light 3 is emitted at certain intervals (Tp) for a certain time (Td). If the received beam level at the light receiving portion 5a exceeds the determination threshold determined in the above-described procedure (Step U3), a detection signal is outputted to the controller 6 (Step U4).

On the other hand, if the received beam level does not exceed the determination threshold in Step U3, the determination threshold used in Step U3 is re-calculated (Step U5) for the next determination operation. The re-calculation can be performed by the same procedure as that for setting the determination threshold in the initialization. For example, the determination threshold can be calculated by multiplying the already-used determination threshold by the number of pulses used in Step U3 as a weight, calculating an average value of the obtained product and a sum of the received beam level in Step U3, calculating a value per pulse by dividing the average value, and adding the threshold constant to the obtained value per pulse.

If the controller 6 receives the outputted detection signal in Step U4 (Step S3), the power source of the reflective optical sensor 5 is turned off (Step S4). Then, whether or not the door is in a closed state is detected (Step S5). If the door is in the closed state, a drive signal to the driver 7 is generated to operate the driver 7, so that the back door 8 is driven to open (Step S6).

### EXPLANATION OF REFERENCE NUMERALS

1 RECESSED HOLLOW SPACE

2 LIGHT EMISSION OPENING

3 DETECTION LIGHT

4 DETECTION TARGET

5 REFLECTIVE OPTICAL SENSOR

6 CONTROLLER

7 CONTROL TARGET

1-7. (canceled)

8. A control structure of a vehicle in which a controller operates a certain control target when a sensor detects an entry of a detection target into a recessed hollow section formed in a vehicle outer wall, wherein
the sensor is a reflective optical sensor configured to emit detection light from a light emitting opening provided in one wall surface of the recessed hollow section toward another wall surface of the recessed hollow section, and to detect the entry of the detection target into the recessed hollow section when a received beam level of an amount of reflected beams of the detection light exceeds a certain determination threshold.

9. The control structure of a vehicle according to claim 8, wherein an optical axis of the reflective optical sensor is directed to an inner side of the vehicle.

10. The control structure of a vehicle according to claim 8, wherein the reflective optical sensor is positioned with the light emitting opening being directed downward.

11. The control structure of a vehicle according to claim 8, wherein the control target is an opening and closing operation controller for a door of the vehicle.

12. The control structure of a vehicle according to claim 8, wherein the reflective optical sensor is an infrared sensor.

13. The control structure of a vehicle according to claim 8, wherein a determination threshold for the detection target used in the reflective optical sensor is determined according to a received beam level at a light receiving portion for a certain time before the determination.

14. The control structure of a vehicle according to claim 8, characterized in that
the structure further comprises detection means for detecting whether or not an electronic key is present within a certain area from the vehicle, and
the controller operates the certain control target when the detection means detects the presence of the electronic key within the certain area from the vehicle and the reflective optical sensor detects the entry of the detection target into the recessed hollow section.
